(19) United States
(12) Patent Application Publication
(10) Pub. No.: US 2007/0229356 A1
(43) Pub. Date: Oct. 4, 2007

(54) Devices, systems and method of determining the location of mobile personnel

(76) Inventor: David S. Kodrin, Trafford, PA (US)

Correspondence Address: James G. Uber, Esq.;Mine Safety Appliances Company, P.O. Box 426, Pittsburgh, PA, 15230-0426, US

(21) Appl. No.: 11/705,891

(22) Filed: Feb. 13, 2007

Related U.S. Application Data
(60) Provisional application No. 60/773,074, filed on Feb. 14, 2006.

(51) Int. Cl. G01S 3/02

(52) U.S. Cl. 342/458

(57) ABSTRACT

A locator system to be associated with a mobile person includes a receiver to receive ultra-wide bandwidth signals and a transmitter to transmit ultra-wide bandwidth signals. The transmitter is adapted to transmit ultra-wide bandwidth signals, and the receiver is adapted to receive ultra-wide bandwidth signals from at least one other locator system. The other locator system includes a receiver to receive ultra-wide bandwidth signals and a transmitter to transmit ultra-wide bandwidth signals. The locator system and the at least one other locator system provide a distance between the locator system and the at least one other locator system so that the locator system can be located without establishing a reference ultra-wide bandwidth locator system. The locator system can be adapted to be in a low-power mode until activated upon communication of an activation signal to the locator system. A safety system is adapted to be associated with a mobile person and includes a locator system including a receiver to receive ultra-wide bandwidth signals and a transmitter to transmit ultra-wide bandwidth signals. The safety system further includes a telemetric communication system adapted to communicate telemetric data and sensor system including at least one sensor adapted to measure at least one parameter. The locator system is adapted to be in a low-power mode until activated upon communication of an activation signal to the locator system. The locator system transmits ultra-wide bandwidth signals periodically and receives periodic ultra-wide bandwidth signals from at least one other like locator system upon activation.

### CROSS-REFERENCE TO RELATED APPLICATIONS

The application is related to U.S. Provisional Patent Application Ser. No. 60/773,074 filed Feb. 14, 2006, the disclosure of which is incorporated herein by reference.

### BACKGROUND OF THE INVENTION

The present invention relates generally to devices, systems and methods of determining the location of mobile personnel and, particularly, to devices, systems and method of determining the location of personnel working under hazardous conditions outdoors or within one or more structures.

Firefighters, first responders, and military personnel work in the world's most dangerous occupations in some of the world's most hazardous environments. Firefighters can easily become disoriented or separated since most firefighting is done in zero visibility as a result of smoke. First responders constantly place themselves in danger, which sometimes results in becoming trapped or disabled. Military personnel face dangerous conditions on a daily basis, and knowing where each soldier is located, whether performing routine tasks or under hostile fire, would be extremely valuable to the commanding officer. In all cases, there are examples where fatalities might have been prevented or injuries lessened in severity with a location system that quickly provides for a distress signal for conscious (or unconscious) personnel and that provides location information for other personnel to quickly find the person in need of assistance.

In cases in which personnel are outdoors, global position system (GPS) devices and solutions can, for example, be used to locate such personnel. However, multipath propagation problems lead to poor signals and inaccurate results with GPS devices when used within a structure. Moreover, GPS devices are typically accurate to approximately ±3 m. Although such inaccuracy can be acceptable for locating personnel and objects outdoors, an inaccuracy of 3 m within a structure can, for example, result in sending a rescue team to a wrong floor within the structure and thus squandering precious time in a rescue mission. Like GPS devices, other localization devices which use, for example, radio frequency energy, ultrasound energy and/or infrared energy can suffer from multipath propagation problems, leading to substantial inaccuracy when used within structures.

In traditional radio frequency or RF communication systems the transmitted electromagnetic power is concentrated in a narrow frequency band. In spread spectrum communication systems, however, the power is distributed over a relatively large bandwidth. Spread spectrum radio communications can, for example, be used in place of traditional systems to circumvent communications jamming by interference signals, prevent detection and interception by unwanted receivers so as to provide privacy, provide tolerance to multipath transmissions, send multiple independent signals over a frequency band, and/or provide accurate ranging information.

Ultra-wide bandwidth (UWB) spread spectrum signals have been used to locate personnel and objects. See, for example, U.S. Pat. Nos. 5,748,891, 6,002,708, 6,3852,68, and 6,400,754, the disclosures of which are incorporated herein by reference. U.S. Pat. No. 6,300,903 and Published U.S. Patent Application Nos. 2003/0144011 and 2005/0228613, the disclosures of which are incorporated herein by reference, disclose location systems in which a plurality of references radios of known position are used to determine the position of one or more mobile radios using UWB or impulse radio communication signals. Although, location systems using UWB signals are quite accurate (for example, ±1 cm), a number of problems persist. For example, power consumption can present a problem in the case of locating mobile personnel over an extended period of time when such personnel are equipped with only a battery power supply. Moreover, establishing reference transmission positions can be difficult and/or very cumbersome in many situations. For example, in an emergency incident (such as a fire) in a large city, there may not be sufficient time or personnel to establish such reference positions. Further, it may not be possible to gain access to certain locations to establish a reference position.

It thus remains desirable to develop improved devices, systems and methods of determining the location of mobile personnel that reduce the severity of or eliminate the above-described and other problems with current location devices, systems and methods.

### SUMMARY OF THE INVENTION

In one aspect, the present invention provides a locator system to be associated with a mobile person. The locator system includes a receiver to receive ultra-wide bandwidth signals and a transmitter to transmit ultra-wide bandwidth signals. The transmitter is adapted to transmit ultra-wide bandwidth signals and the receiver is adapted to receive ultra-wide bandwidth signals from at least one other locator system. The other locator system includes a receiver to receive ultra-wide bandwidth signals and a transmitter to transmit ultra-wide bandwidth signals. The locator system and the at least one other locator system provide a distance between the locator system and the at least one other locator system so that the locator system can be located without establishing a reference ultra-wide bandwidth locator system.

In another aspect, the present invention provides a locator system to be associated with a mobile person. The locator system includes a receiver to receive ultra-wide bandwidth signals and a transmitter to transmit ultra-wide bandwidth signals. The transmitter is adapted to transmit ultra-wide bandwidth signals and the receiver is adapted to receive ultra-wide bandwidth signals from at least one other locator system. The at least one other locator system includes a receiver to receive ultra-wide bandwidth signals and a transmitter to transmit ultra-wide bandwidth signals. The locator system is adapted to be in a low-power mode until activated upon receipt of an activation signal.

In a further aspect, the present invention provides a safety system adapted to be associated with a mobile person. The safety system includes a locator system including a receiver to receive ultra-wide bandwidth signals and a transmitter to transmit ultra-wide bandwidth signals. The safety system further includes a telemetric communication system adapted to communicate telemetric data and a sensor system including at least one sensor adapted to measure at least one parameter. The locator system is adapted to be in a low-power mode until activated upon communication of an activation signal to the locator system. The locator system transmits ultra-wide bandwidth signals periodically and receives periodic ultra-wide bandwidth signals from at least one other like locator system upon activation.

An activation signal can, for example, be communicated to the locator system upon the at least one parameter measured by the sensor being within a threshold range, upon manual activation of an actuator of the safety system or upon receipt by the safety system of an activation transmission. In one embodiment, the activation transmission is transmitted to the safety system upon a parameter measured by a sensor system of a like safety system being determined to be within a threshold range.

The telemetric communication system can transmit data corresponding to the at least one parameter. The telemetric communication system can, for example, include a narrow band radio receiver and a narrow band radio transmitter. In one embodiment, the safety system further includes a controller in operative communication with the ultra-wide bandwidth receiver, the ultra-wide bandwidth transmitter, the narrow band radio receiver, the narrow band radio transmitter and the sensor system. The safety system can further include a power supply in operative communication with the ultra-wide bandwidth receiver, the ultra-wide bandwidth transmitter, the narrow band radio receiver, the narrow band radio transmitter and the sensor system.

In one embodiment, the safety system is in operative connection with a self contained breathing apparatus. The sensor system can, for example, include a motion sensor to detect motion of the person. The locator system can, for example, be powered upon activation of the self contained breathing apparatus. In one embodiment, the sensor system can include a motion sensor to detect motion of the person and a sensor to measure pressure in a tank of breathing gas forming a part of the self contained breathing apparatus.

In another aspect, the present invention provides a network system including a plurality of locator systems. Each of the locator systems includes a receiver to receive ultra-wide bandwidth signals and a transmitter to transmit ultra-wide bandwidth signals. The transmitter is adapted to transmit ultra-wide bandwidth signals and the receiver is adapted to receive ultra-wide bandwidth signals from at least one other locator system. The at least one other locator system includes a receiver to receive ultra-wide bandwidth signals and a transmitter to transmit ultra-wide bandwidth signals. The locator system is adapted to be in a low-power mode until activated upon receipt of an activation signal. The plurality of locator systems can, for example, form an ad hoc network. The plurality of locator systems can also form a mesh network.

In a further aspect, the present invention provides a network system including a plurality of safety systems, wherein each safety system is adapted to be associated with a mobile person. Each safety system includes a locator system including a receiver to receive ultra-wide bandwidth signals and a transmitter to transmit ultra-wide bandwidth signals. The safety systems further include a telemetric communication system adapted to communicate telemetric data and a sensor system including at least one sensor adapted to measure at least one parameter. The locator system is adapted to be in a low-power mode until activated upon communication of an activation signal to the locator system. The locator system transmits ultra-wide bandwidth signals periodically and receives periodic ultra-wide bandwidth signals from at least one other like locator system upon activation. The plurality of safety systems can, for example, form an ad hoc network. The plurality of safety systems can also form a mesh network.

In another aspect, the present invention provides a locator system to be associated with a mobile person including a receiver to receive spread spectrum signals and a transmitter to transmit spread spectrum signals. The transmitter is adapted to transmit spread spectrum signals, and the receiver is adapted to receive spread spectrum signals from at least one other locator system. The other locator system includes a receiver to receive spread spectrum signals and a transmitter to transmit spread spectrum signals. The locator system and the at least one other locator system provide a distance between the locator system and the at least one other locator system so that the locator system can be located without establishing a stationary reference to within an accuracy of ±2 m.

The locator system can further include a power source in operative connection with the receiver and the transmitter. The power source can also be in operative connection with a personal alert safety system comprising a motion sensor. The locator system can also include a controller in operative connection with the receiver and the transmitter. The controller can also be in operative connection with a narrow band radio system.

In one embodiment, the receiver is adapted to receive ultra-wide bandwidth signals, and the transmitter is adapted to transmit ultra-wide bandwidth signals. The locator system can, for example, have an accuracy of approximately ±1 m. The locator system can also have an accuracy of approximately ±1 cm.

The locator system can be adapted to be in a low power mode until reception of an activation signal.

In still a further aspect, the present invention provides a safety system adapted to be associated with a mobile person including a locator system including a receiver to receive electromagnetic signals and a transmitter to transmit electromagnetic signals. The safety system further includes a personal alert safety system including a motion sensor. A power source can be in operative connection with the receiver, the transmitter and the personal alert safety system. The locator system is adapted to transmit electromagnetic signals periodically to and receive periodic electromagnetic signals periodically from at least one other like locator system.

The locator system can further include a telemetric communication system adapted to communicate telemetric data. The telemetric communication system can also be in operative connection with the power source. The telemetric communication system can, for example, include a narrow band radio receiver and a narrow band radio transmitter. In one embodiment, the locator system further includes a controller in operative connection with the receiver, the transmitter, the narrow band radio receiver and the narrow band radio transmitter.

The locator system can be adapted to be in a low power mode until reception of an activation signal.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic representation of an embodiment of an integrated safety system including a locator system of the present invention for use in connection with a self contained breathing apparatus (SCBA) system.

FIG. 1B illustrates a schematic representation of an embodiment of a standalone locator system of the present invention.

FIG. 1C illustrates a perspective view of an SCBA system including an embodiment of the integrated safety system of FIG. 1A in operative connection therewith and an embodiment of a standalone locator system of FIG. 1B adjacent thereto.

FIG. 2A illustrates a schematic representation of a plurality of integrated safety systems of FIG. 1A at various positions within a structure, wherein the UWB transceiver of one of the safety systems has been placed in a beacon mode to provide its location.

FIG. 2B illustrates a schematic representation of a standalone locator system of FIG. 1B placed in an active, beacon mode after communication of an activation or alarm signal to the locator system.

FIG. 2C illustrates a schematic representation of a network of a plurality of safety systems of FIG. 1A within a structure, wherein the UWB transceivers of all of the safety systems are placed in an active mode to, for example, form an ad hoc network and to provide the location of each of the safety systems.

FIG. 2D illustrates an embodiment of a display of one of the safety systems of FIG. 2C.

FIG. 2E illustrates an embodiment of a display of a rescue monitor system of FIG. 2C.

FIG. 3 illustrates a flow chart of an embodiment of a method of operation of the safety system of FIG. 1A.

FIG. 4 illustrates several pages of an embodiment of a display of an incident command center of the present invention.

FIG. 5A illustrates the use of three locator systems of the present invention to provide a two-dimensional position map.

FIG. 5B illustrates the use of four locator systems of the present invention to provide a three-dimensional position map, wherein the fourth locator system is out of plane with the other three locator systems.

### DETAILED DESCRIPTION OF THE INVENTION

In several embodiments, the present invention provides locator systems for use in determining the position or location of one or more mobile persons (for example, working in a dangerous or hazardous environment). In several embodiments, such systems include a plurality of mobile locators. Each of the mobile locators is operable or adapted to be associated with (for example, worn by, carried by etc.) one of a plurality of mobile persons. Each of the mobile locators includes a receiver and a transmitter (which can be combined in a transceiver as known in the art) that are operable to receive and transmit, respectively, signals that can be processed to determine the location of the persons. In several embodiments of the present invention, the plurality of mobile locators also forms a communication network wherein periodic signal transmissions provide information regarding the position or location of each of the mobile locators.

In several embodiments of the present invention, the transmitter and the receiver are adapted to transmit and receive, respectively, spread spectrum electromagnetic communications. Preferably, the mobile locators include at least one antenna for transmission and/or reception of ultra-wide bandwidth (UWB) signals. In several embodiments, the locators determine relative and/or absolute locations or positions in three-dimensional space to preferably within ±2 m and, more preferably, within ±1 m by, for example, cooperatively measuring propagation times of pseudorandom sequences of electromagnetic impulses as described in U.S. Pat. Nos. 5,748,891, 6,002,708, 6,3852,68, 6,400,754 and in Fleming, R. et al., “Rapid Acquisition for UWB Transceivers”, 2002 IEEE Conference on Ultra Wideband Systems and Technologies, 22 May 2002, of Aether Wire & Location, Inc., a copy of which is attached hereto and is incorporated herein by reference. Using UWB signals, the locators of the present invention can also determine relative and/or absolute locations or positions in three-dimensional space to within ±1 cm. Preferably, electromagnetic energy having a frequency suitable to facilitate transmission through structures without substantial multipath propagation problems is used. For example, electromagnetic energy in the frequency range of 100 MHz to 1 GHz can be used.

In general, the terms “ultra-wide bandwidth” and “UWB” (as defined by the U.S. Federal Communications Commission) refer to radio signals having either a fractional bandwidth (i.e., the ratio between the signal's bandwidth and its center frequency) that is greater than 0.2 or an absolute bandwidth of at least 500 MHz. The term “spread spectrum” refers to signals occupying a bandwidth larger than the spectral content of the transmitted information. In other words, the signal is “spread” over a frequency band wider (and typically much wider) than the minimum bandwidth needed to transmit the information being sent.

The mobile locators of the present invention can be “standalone” or separate devices worn by mobile personnel. However, it can be desirable, when possible, to integrate the mobile locators of the present invention into, for example, communications and other electronic systems that are currently used by mobile personnel. Several embodiments of the present invention are, for example, discussed below in connection with the integration of the mobile locators of the present invention into a self contained breathing apparatus (SCBA) system worn by firefighters. The mobile locators of the present invention can, for example, share power sources, controllers, enclosures or housings etc. with such other systems. Certain economies can be achieved in, for example, communications, power consumption and volume/weight of equipment required to be worn by firefighters and other mobile personnel.

For example, many mobile personnel are equipped with narrow band radio transmitting/receiving systems to, for example, transmit voice and/or telemetric data. The mobile locator systems of the present invention can be integrated with such narrow band radios (NBR) systems such that, for example, UWB and NBR signals can be controlled via a common controller. Moreover, UWB signals can provide a backup system (or a primary system) to, for example, transmit telemetric data. In that regard, a person that works in hazardous environments is often provided with one or more sensor systems to measure values of parameters relevant to the safety of the person. In the case of a firefighter, for example, the firefighter may be equipped with sensors including, but not limited to, one or more sensors to measure various biometric values (for example, heart rate, blood pressure, respiration etc.), one or more sensors to measure motion, one or more sensors to measure one or more variables relative to the status of a self-contained breathing apparatus (for example, an air tank pressure sensor) and/or one or more sensors to measure environmental conditions (for example, temperature). In current systems, telemetric data from such sensors is transmitted to an incident command via narrow band radio. Motion sensors used by firefighters are commonly referred to as PASS (personal alert safety system) alarms. Once a firefighter has been immobile for a predefined or threshold period of time the PASS sounds an audible alarm (to assist in locating the firefighter). A signal of the PASS alarm can also be communicated via a narrow band radio to incident command. A PASS alarm suitable for use in the present invention is disclosed, for example, in U.S. Pat. No. 6,198,396, the disclosure of which is incorporated herein by reference.

In several embodiments of the present invention, the locator systems of the present invention are initially placed in a low-power or sleep mode and subsequently placed in a fully active mode (in which signals are transmitted/received) only upon communication of an activation signal. As used herein, the term “low power” includes all reduced power states (as compared to a fully active state), including a powered off state. The activation signal can, for example, be transmitted upon a determination that one or more parameter values measured by one or more sensor systems associated with at least one person have entered a threshold range (for example, indicating a distress state of that person and/or other persons). In several embodiments, the activation signal can also be manually activated by the person wearing a mobile locator and/or transmitted by an incident command center. The mobile locators of the present invention can, for example, be adapted to be in a low-power, inactive or sleep mode until an activation signal is communicating as described above, causing one of, a plurality of, or all of the mobile locators to enter an active mode.

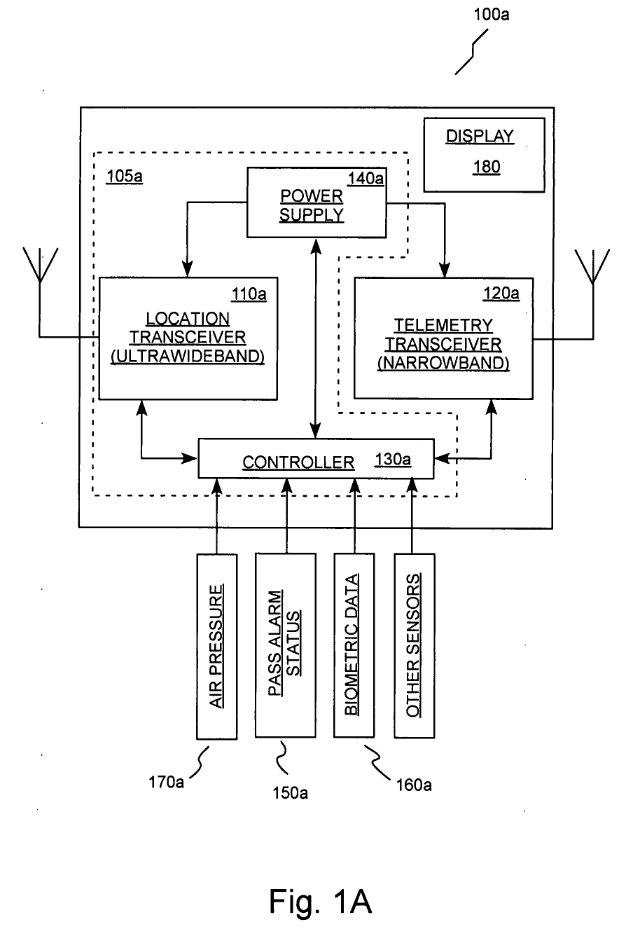

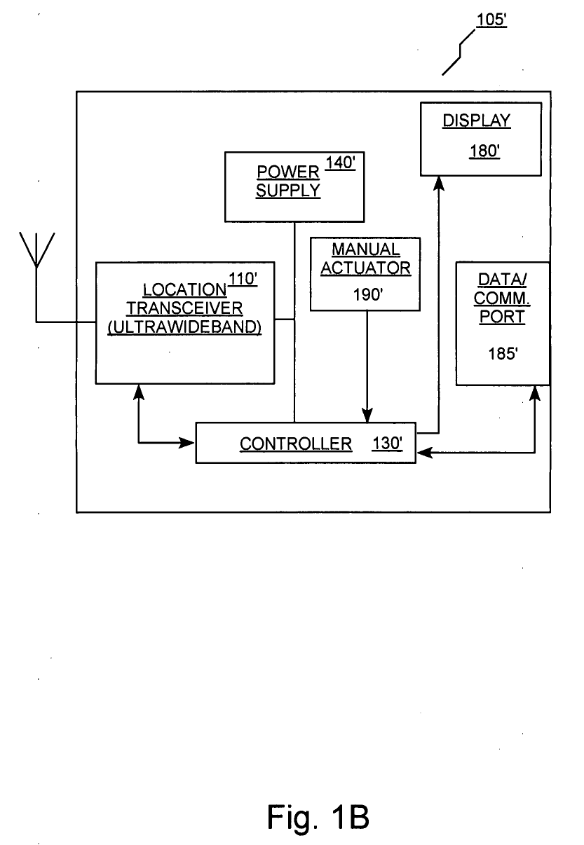

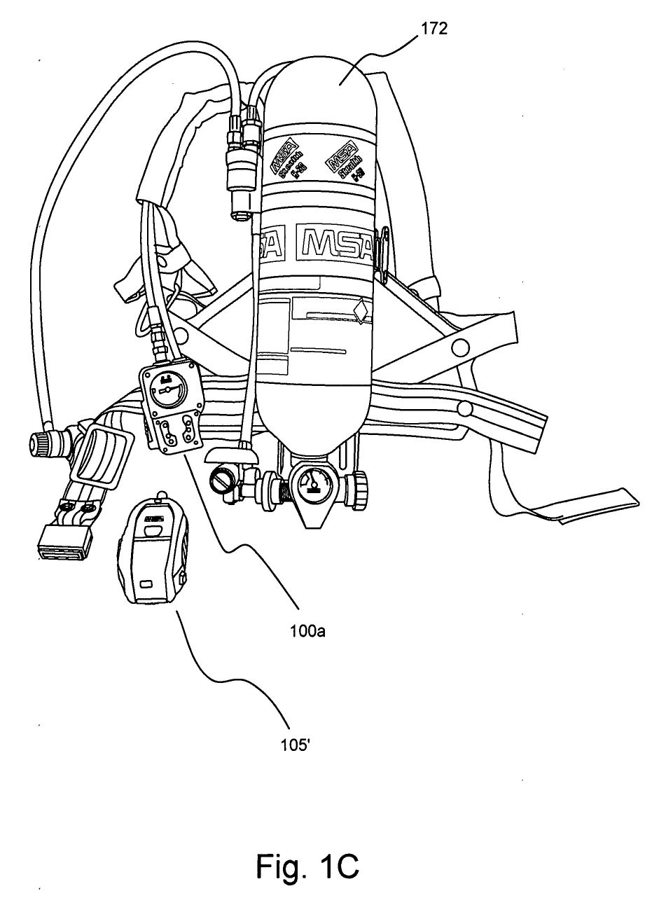

A representative embodiment of an integrated system of the present invention incorporating a locator system, an NBR communication system and a sensor system is illustrated in FIG. 1A. In the illustrated embodiment of FIG. 1A, the locator system is integrated within existing circuitry found in an SCBA system. In the case of most serious fire incidents, an SCBA is mandatory equipment. The SCBA is always activated once a firefighter is present at a fire scene incident. The SCBA provides a convenient platform into which automatic location determining or locator electronics can be integrated. Recently, the SCBA has become a vehicle for many different sensor systems (such as described above), each of which requires a power source and control circuitry. By integrating the mobile locators of the present invention or other mobile locators with the SCBA and other vital life-preserving equipment, the opportunity exists to facilitate transmission of valuable information (e.g. air pressure, PASS alarm status, etc.) along with location data.

Moreover, a two-way communication link can exist between each firefighter and the incident commander, and evacuation signals, search signals and/or other signals can also be transmitted from the incident command center or base station to the SCBA. In that regard, present state-of-the-art SCBAs currently incorporate a narrowband radio for transmission of pertinent data from the wearer's location to the incident command center. This system is bi-directional, also allowing data from incident command (e.g. evacuate, search, etc.) to be passed to the wearer.

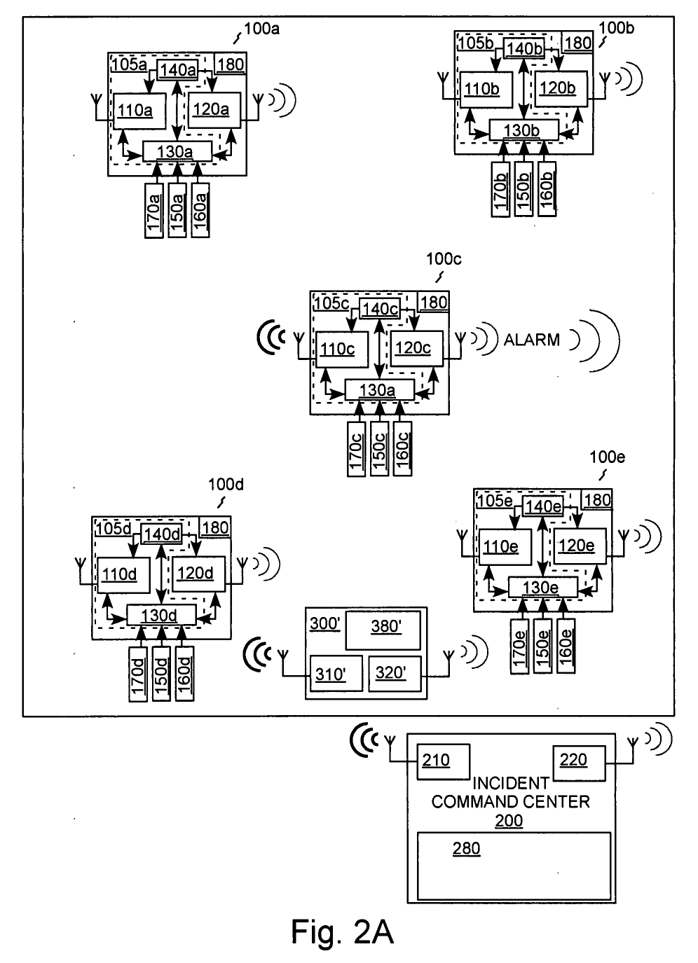

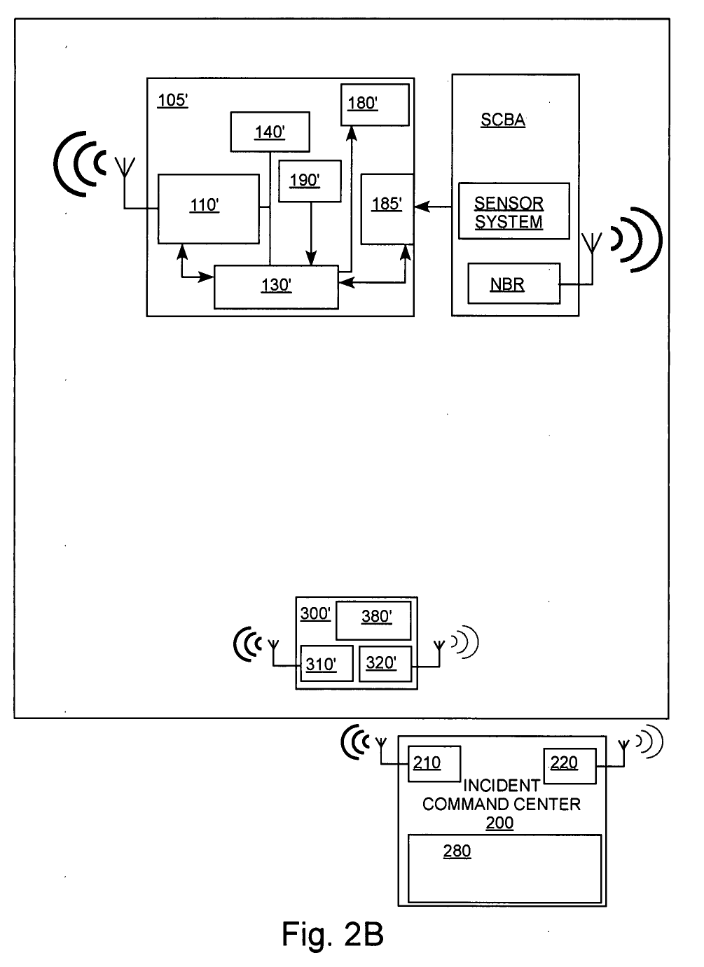

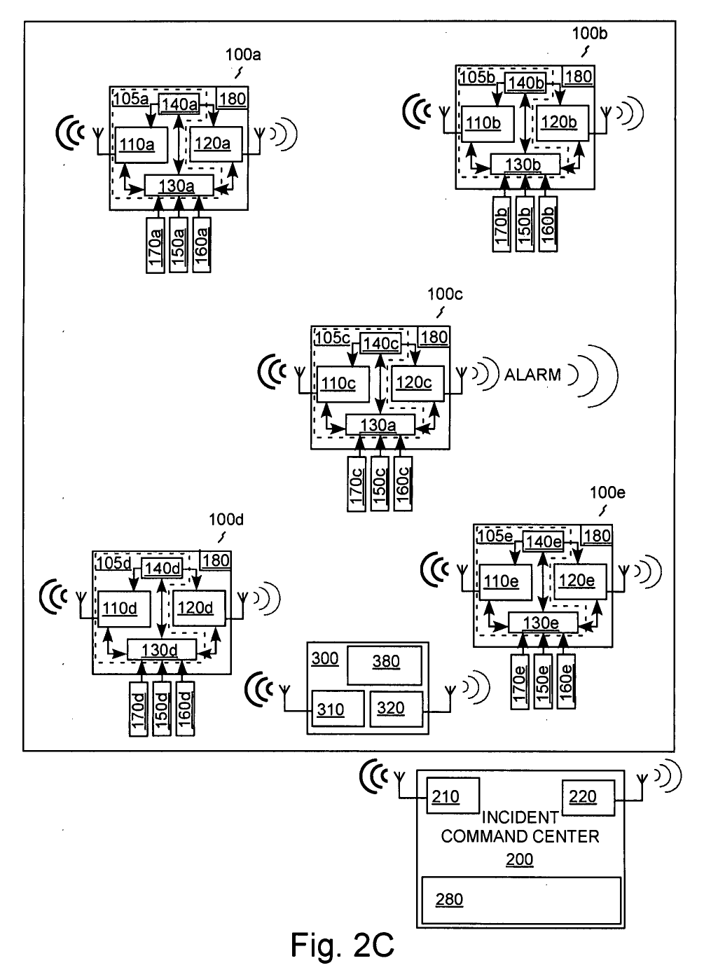

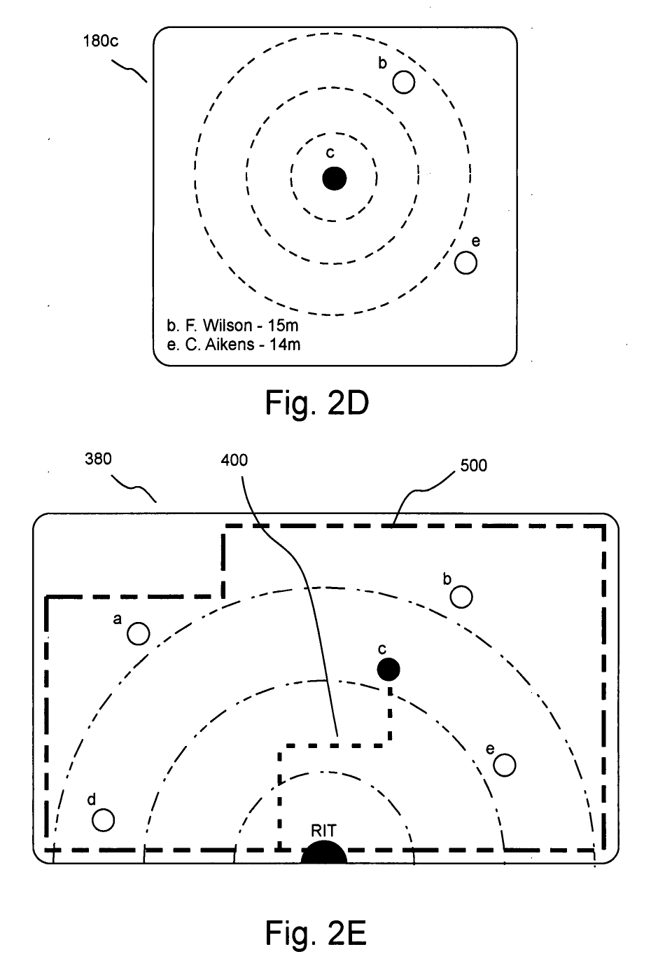

As illustrated in FIG. 1A, safety system 100a (for example, electronically and/or physically integrated with SCBA electronics) of the present invention includes a mobile locator system 105a including an ultra-wide bandwidth (UWB) location transceiver 110a. Safety system 100a also includes a narrowband radio (NBR) telemetry transceiver 120a. NBR telemetry transceiver 120a and UWB location transceiver 110a share a common controller 130a (for example, a microcontroller as known in the art) and a common power source 140a (for example, a battery). NBR telemetry transceiver 120a, UWB location transceiver 110a and common or shared components thereof can be enclosed in a common housing or enclosure. Safety system 100a is worn by a firefighter such as is currently practiced for PASS alarms integrated with SCBA systems. Safety system 100a also includes one or more systems to sense and communicate status information related to the safety of the person wearing safety system 100a and communicate such information to one or more incident command centers 200 (see, for example, FIG. 2C), which can be located outside of the hazardous environment. The sensed or measured status information can include, for example: alarm status of a PASS 150a; information from one or more biometric data sensors 160a; and information from an air pressure sensor 170a in operative connection with a tank of breathing gas 172 (see FIG. 1C). Many other types of sensing equipment or sensors 180a for measuring these and other parameters can be included in the present invention. As currently practiced in SCBA integrated systems, NBR transceiver 120a transmits sensed status information to the incident command center. Such status information can be monitored and analyzed to provide a measure of the overall safety or condition status of personnel within the hazardous environment.

Combining NBR telemetry transceiver 120a and UWB location transceiver 110a in safety system 100a (for example, an integrated SCBA system), can provide functionality not available from either NBR transmission or UWB transmission individually or when used together as stand-alone systems. For example, efficient power management is provided through use of common power supply or source 140a. For many first responders, battery life to power these self-worn electronic products is a premium commodity. As mentioned earlier, the sharing of a common power supply greatly reduces the weight and size of an integrated system over several stand-alone systems.

Moreover, effective spectrum management can be provided through intelligent signaling between narrow-band and ultra-wide band systems. Microcontroller 130a can, for example, handle all communication traffic within the electronics module of safety system 100a to ensure that all sensors are not continuously (and needlessly) transmitting, thereby saving valuable energy resources. The data traffic handled by microcontroller 130a can include, but is not limited to, input/output port data (for example, air pressure sensors, temperature sensors, motion sensors, etc.), UWB radio module data, and narrowband radio module data. Also, by closely monitoring radio traffic, unnecessary transmissions are reduced or eliminated, thereby substantially extending battery life.

Further, integration of NBR telemetry transceiver 120a and UWB location transceiver 110a can provide a redundant transmission system for important biometric data or evacuation signals. NBR telemetry transceiver 120a does not participate in determinations of locations and is generally limited to information sharing and signaling. However, such data and/or signaling can be transmitted by either or both of NBR telemetry transceiver 120a and UWB location transceiver 110a.

Once again, although several embodiments of the present invention are discussed in connection with integration of a UWB location transceiver with other components of a safety system (and particularly an SCBA), one skilled in the art appreciates that the locator systems (including UWB location transceivers) of the present invention can also be provided in “standalone” or nonintegrated embodiments. FIG. 1B illustrates a representative embodiment of an standalone locator system 105′ of the present invention. Locator system 105′ includes an ultra-wide bandwidth (UWB) location transceiver 110′. UWB location transceiver 110′ is in communicative connection with a controller or processor 130′ (for example, a microcontroller as known in the art) and a power source 140′ (for example, a battery). Controller 130′ can also be in communicative connection with a display 180′ to, for example, provide an indication of other locator systems including a UWB locator system in the near vicinity. Safety system 105′ is, for example, worn by a firefighter. The firefighter can also be equipped with an SCBA system as described above. Locator system 105′ can, for example, include a data/communication port 185′ (for example, including a narrow band radio transceiver) via which, for example, data of a sensor alarm (for example a PASS alarm or an SCBA pressure alarm; see, for example, FIG. 2C) or other activation signal can be communicated to locator system 105′. Upon communication of such an alarm, UWB location transceiver 110′ can be taken out of a sleep mode and placed in an active mode as described above. Locator system 105′ can also include a manual actuator 190′ to enable manual activation of UWB location transceiver 110′.

FIG. 2A illustrates an embodiment of a communication and location system of the present invention in which safety system 100c of a plurality of integrated safety systems 100a-e of the present invention (as described above) is placed in a “beacon mode”. In this embodiment, each individual (for example, a firefighter at a fire scene) is equipped with one of the plurality of safety systems 100a-e. Each of safety systems 100a-e constantly monitors the status of the various system sensors as well as communications from incident command center 200. Upon, for example, an alarm signal from a motion sensor of PASS 150c (corresponding to a determination of lack of motion of the firefighter) or other alarm signal, UWB location transceiver 110c is activated to provide a signal which, for example, allows a rescue team (for example, a rapid intervention team or RIT as sometimes present at a fire scene) equipped with a monitor system 300 having a locator system including an UWB transceiver 310 to determine a distance between safety system 100c (and the wearer thereof) and the rescue team. In addition to activation by a sensor alarm, any one or more of UWB location transceivers 110a-c, can also be activated manually (with, for example, a ‘panic’ button). It is not necessary that the absolute position of safety system 100c be determined. It has been determined that the relative position of safety system 100c (that is, relative to, for example, one or more rapid intervention or rescue team monitor systems 300 and/or other safety systems 100a, b, d and/or e) is sufficient to allow relatively quick location of safety system 100c. Thus, UWB transmissions from reference positions need not be established.

Rapid intervention or rescue team monitor system 300 can, for example, include UWB location transceiver 310 and a narrow band radio transceiver 320 to, for example, transmit and receive telemetric data as described above. Monitor system 300 can also include a display 380 to, for example, provide a graphical representation and/or other indication of the determined position/distance of UWB transmitting safety system 100c. Display 380 (or other indicator) can set forth the distance to safety system 100c and the downed firefighter in, for example, feet or meters relative to the position of monitor system 300, thus providing a guide to the position of safety system 100c and the downed firefighter. UWB transceiver 310 can, for example, be constantly activated during an incident, providing the rapid intervention or rescue team with substantially instantaneous identification of a firefighter in need. Alternatively, UWB transceiver 310 can be in a low power state until an activation signal is received by monitor system 300 (for example, via a transmission to NBR transceiver 320). In the event of, for example, an injury to a rapid intervention or rescue team member, transceiver 310 can also become a beacon for another search receiver.

FIG. 2B illustrates a similar operative mode to that described in FIG. 2A for standalone locator system 105′. In the illustrated embodiment, a signal of, for example, a PASS alarm or an SCBA pressure alarm, is transmitted from the SCBA to locator system 105′ via data communication port 185′ to activate UWB location transceiver 110′ into a beacon mode as described in connection with FIG. 2A. As described above, display 380 can set forth the distance to locator system 105′ in, for example, feet or meters, thereby providing a guide to the position of locator system 105′ and the distressed firefighter wearing locator system 105′.

FIG. 2C illustrates an embodiment of a communication and location network formed from a plurality of safety systems 100a-e. Although five safety systems 100a-e are illustrated in the communication and location network of FIG. 2B, one skilled in the art appreciates that fewer than five or greater than five such safety systems can be present in a communication and location network of the present invention. Once again, each of a plurality of mobile persons (for example, firefighters) is equipped with and wears one of safety systems 100a-e. The plurality of safety systems 100a-e form the communication and location network, wherein UWB locating impulse signals can provide information regarding the location of each of the plurality of safety systems 100a-e and, thereby, the location of each of the plurality of persons wearing one of safety systems 100a-e. Incident command center 200, including a UWB location transceiver 210a and an NBR telemetry transceiver 220a, can form part of the communication and location network and monitors the communications for each mobile person. Incident command center 200 can also transmit signals such as an evacuation command signal via, for example, NBR telemetry transceiver 220a. Rapid intervention team monitor system 300 can also form part of the communication and location network.

In one embodiment, when an activation signal corresponding, for example, to an alarm or distress state is signaled by one of NBR transceivers 120a-e (for example, a PASS alarm or an SCBA pressure alarm from safety system 100c), an activation mode is entered (for example, upon transmission of an activation signal from NBR transceiver 220 or incident command center 200 to NBR transceivers 120a, b, d and e other safety systems 100a, b, d and e as well as to NBR transceiver 320 of monitor system 300) wherein all of mobile locator systems 105a-e (as well the locator system of monitor system 300) are taken out of a low-power or sleep mode and placed into an active mode corresponding, for example, to a locating mode wherein UWB transceivers 110a-e, and 210 are activated. Signal pulses from each of UWB transceivers 110a-e, 310 are periodically communicated to provide the location of safety system 100c (and the location of other safety system 100a, b, d and e and monitor system 300) as, for example, discussed in U.S. Pat. Nos. 5,748,891, 6,002,708, 6,3852,68, and 6,400,754. The position(s) of a person or persons requiring assistance are thus established. Once again, relative positions between two or more locator systems are typically suitable to enable relatively quick localization. However, one or more reference positions (that is, stationary locator systems or locator systems of know position including UWB transceivers) can be established to provide “absolute” positions.

UWB transceivers 110a-e of safety systems 100a-e can, for example, form an mobile ad-hoc network. The mobile ad-hoc network is a self-configuring network wherein safety systems 100a-e (operating as mobile routers and associated hosts) are connected by wireless links and form an arbitrary topology. In forming an ad-hoc network, safety systems 100a-e of the present invention are free to move randomly and organize themselves arbitrarily. The wireless topology of the communication and location network can thus be allowed to change rapidly and unpredictably. The network can operate in a standalone fashion, or can be communicatively connected to one or more other networks. Minimal configuration and quick deployment make ad hoc networks well suited for emergency situations or incidents such as fire incidents. The ad hoc network(s) can form a mesh network. In general, mesh networking enables routing of data between nodes (safety systems 100a-e) and allows for continuous connections and reconfiguration around blocked paths by “hopping” from node to node until a connection can be established. Mesh networks are self-healing in that the network can still operate even when a node breaks down or a connection goes bad. As a result, a very reliable network is formed. Ad hoc networking with UWB transceivers is, for example, discussed in the presentation of Aether Wire and Location, Inc. entitled “CMOS UWB Localizers for Networking in the Extreme (NETEX)”, presented at the DARPA NETEX Industry Day, 10 Sep. 2001, a copy of which is attached hereto and incorporated herein.

FIG. 2D illustrates an embodiment of display 180c (or a portion thereof) of safety system 100c after activation of UWB location transceiver 100c (as well as UWB location transceivers 100a, b, d, and e) as described in connection with FIG. 2C. Given size and weight limitations for articles worn by mobile personal, display 180c can be somewhat small in size. Thus, the amount of information provided on display 180c at any one time can be limited. In FIG. 2D, for example, the relative positions of safety systems other than safety system 100c within a defined distance are set forth on display 180c. In the illustrated embodiment, the positions (b and e, respectively on FIG. 2D) of only safety systems 100b and 100e are close enough to the position (c) of safety system 100c to be indicated on display 180c. The names of the person(s) in the vicinity of safety system 100c and the distance of those persons from safety system 100c can additionally or alternatively be displayed as illustrated in Figure D. The indication to a wearer of an integrated safety system or a standalone locator system of the present invention of the position(s) of one or more nearby wearers of other safety systems or locator systems can facilitate self rescue in certain situations (for example, disorientation or momentary lack of contact with the rest of the team) and provide reassurance of increased safety. Moreover, display 180c and other displays 180a, b, d and e also facilitate use of locator systems 105a-e in a search mode to assist in rescue operations.

FIG. 2E illustrates an embodiment of display 380 (or a portion thereof) of monitor system 300 after activation of UWB locator transceivers 110a-e upon, for example, a PASS alarm signal or other alarm signal from safety system 100c. Display 380 can, for example, be large and include more information on a single screen display than display 180c.

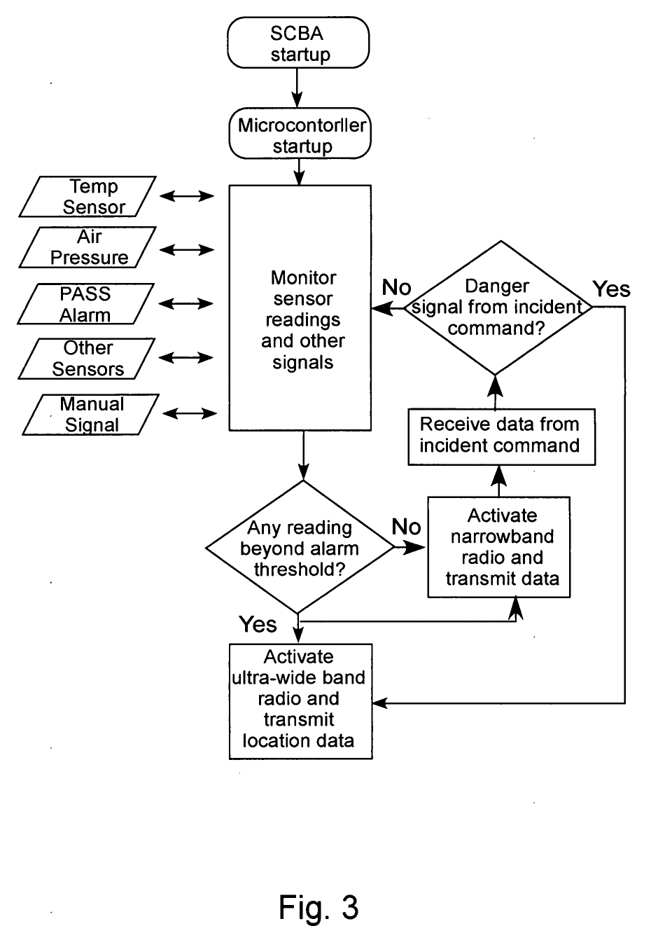

FIG. 3 illustrates a flowchart of one embodiment of an operational mode for the communication and location network of Figure C depicting how various sensed and communicated states or conditions affect the operation of the communication and location network. In the embodiment of FIG. 3, each of safety systems 105a-e is integrated with an SCBA as described above. Upon activation of the SCBA, each of safety systems 105a-e is automatically activated. Microcontrollers 130a-e are activated and monitor data communications from all systems sensors as well as from incident command center 200. NBR transceivers 120a-e communicate sensed data to incident command center 200. If one of the system sensors communicates data to one of microcontrollers 130a-e that exceeds an alarm threshold the UWB transceiver of the corresponding mobile locator system is activated and begins transmitting a signal. A signal corresponding to the alarm threshold state is also communicated to, for example, incident command center 200 via the corresponding NBR transceiver.

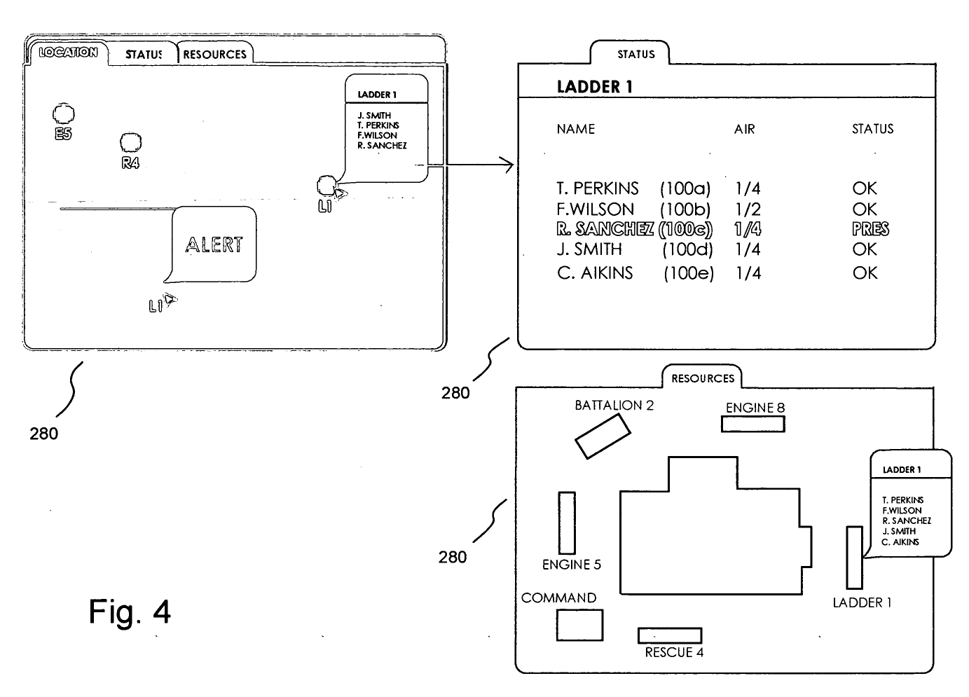

FIG. 4 illustrates an embodiment of display 280 of incident command center 200. Display 280 can be relatively large (as considerations of size and weight are not of critical importance to incident command center 200). In the illustrated embodiment, display 280 includes several pages including, for example, one or more pages providing the location of all teams at an incident, one or more pages including the status of personnel (provided telemetrically as described above) and one or more pages providing a snapshot of all resources and the fire ground. The one or more pages setting forth the location of teams can, for example, be enhanced or enlarged for certain teams to provide the positions of the team members (as, for example, illustrated in FIG. 2E for display 380).

As discussed above, battery life is preferably maximized in the mobile devices, systems and methods of the present invention. Currently available UWB transceivers have relatively high power requirements. Several embodiments of the devices, systems and methods of the present invention provide value to firefighters in danger by activating only when an activation signal is communicated (for example, when a PASS alarms). Whether activated to a full-location mode or to a beacon transmission mode, having the UWB transceivers activate only when signaled by the NBR transceivers conserves valuable battery life. However, as UWB transceivers become significantly more power efficient, and, consequently, have significantly less impact on other power systems, UWB signals can be communicated continuously through the entire duration of an incident.

In the case that UWB transceivers remain constantly active, it can be beneficial to track and display a path a mobile person has taken (at least for a defined period of time prior, for example, to a sensor alarm or other indication of distress) to facilitate location. For example, FIG. 2E illustrates a path 400 take by a firefighter wearing safety system 100c. FIG. 2E also illustrates a boundary 500 of a particular structure (or a portion thereof) in which firefighters wearing safety systems 100a-e are present. Such boundaries can, for example, be established by one or more firefighter performing a “walk-around” upon initial survey of the fire scene. A data point can, for example, be manually entered into the system at each corner to establish boundary 500. Alternatively, structures can be pre-equipped with one or more suitable UWB transmission devices for establishing such corners/boundaries.

Mesh networking technology and/or other technologies, as described above, allow several firefighters, each utilizing one or more UWB location transceivers such as provided in safety systems 100a-e, to possess distance awareness to each firefighter on the scene. Because the distance to each transceiver is known, each transceiver on the network will also provide the distance to every other transceiver. Geometric calculations can be performed to determine the relative positions of each node in the network, leading directly to a 3D visualization of each firefighter at the site.

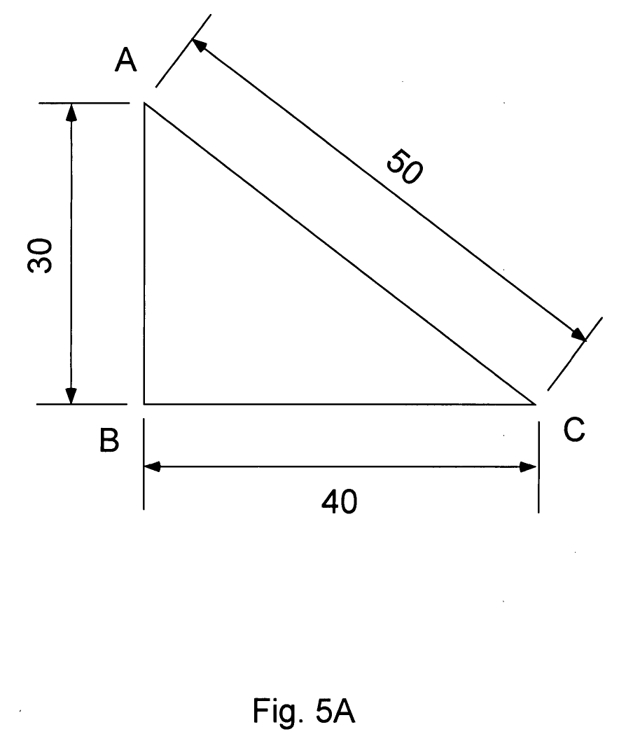

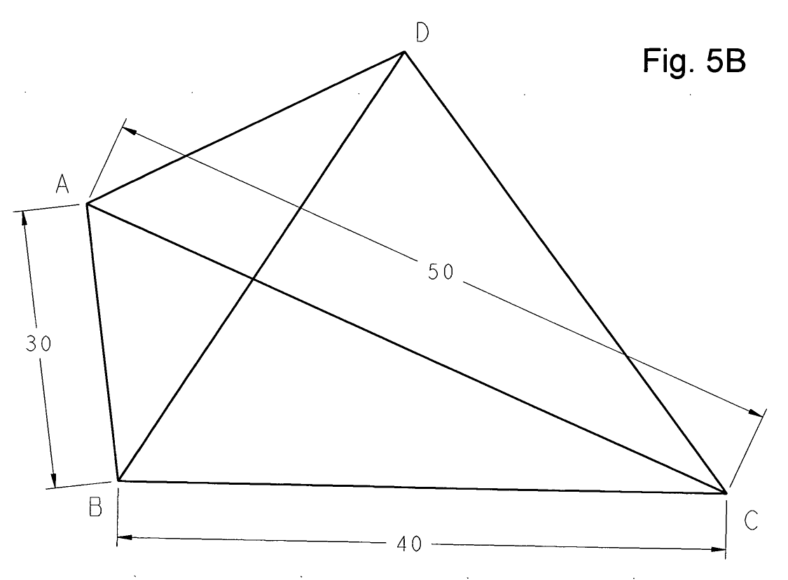

To demonstrate this concept, FIG. 5A illustrates three transceivers (A, B, and C) that provide the distance to each of the other transceivers. If A is 30 feet from B, B is 40 feet from C, and C is 50 feet from A, it can be calculated that A, B, and C form a right angle triangle in space. Four or more transceivers are required to “anchor” these points in space but, as long as distance information is freely and accurately communicated between each node, a three-dimensional representation of each transceiver on the scene is possible as illustrated in FIG. 5B in which a fourth transceiver D is present. By associating this information with key biometric and/or alarm data as described above, an incident commander or other person can easily distinguish the location of those firefighters in danger.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A locator system to be associated with a mobile person, comprising:
a receiver to receive ultra-wide bandwidth signals and a transmitter to transmit ultra-wide bandwidth signals;
the transmitter being adapted to transmit ultra-wide bandwidth signals and the receiver being adapted to receive ultra-wide bandwidth signals from at least one other locator system, the other locator system comprising a receiver to receive ultra-wide bandwidth signals and a transmitter to transmit ultra-wide bandwidth signals;
the locator system and the at least one other locator system providing a distance between the locator system and the at least one other locator system so that the locator system can be located without establishing a reference ultra-wide bandwidth locator system.

2. The locator system of claim 1 wherein:
the locator system is adapted to be in a low-power mode until activated upon receipt of an activation signal.

3. A safety system adapted to be associated with a mobile person, comprising:
a locator system comprising a receiver to receive ultra-wide bandwidth signals and a transmitter to transmit ultra-wide bandwidth signals;
a telemetric communication system adapted to communicate telemetric data;
a sensor system comprising at least one sensor adapted to measure at least one parameter,
the locator system being adapted to be in a low-power mode until activated upon communication of an activation signal to the locator system, the locator system transmitting ultra-wide bandwidth signals periodically and receiving periodic ultra-wide bandwidth signals from at least one other like locator system upon activation.

4. The safety system of claim 3 wherein an activation signal is communicated to the locator system upon the at least one parameter measured by the sensor being within a threshold range, upon manual activation of an actuator of the safety system or upon receipt by the safety system of an activation transmission.

5. The safety system of claim 4 wherein the activation transmission is transmitted to the safety system upon a parameter measured by a sensor system of a like safety system being determined to be within a threshold range.

6. The safety system of claim 3 wherein the telemetric communication system transmits data corresponding to the at least one parameter.

7. The safety system of claim 3 wherein the telemetric communication system comprises a narrow band radio receiver and a narrow band radio transmitter.

8. The safety system of claim 7 wherein the safety system further comprises a controller in operative communication with the ultra-wide bandwidth receiver, the ultra-wide bandwidth transmitter, the narrow band radio receiver, the narrow band radio transmitter and the sensor system.

9. The safety system of claim 8 wherein the safety system further comprises a power supply in operative communication with the ultra-wide bandwidth receiver, the ultra-wide bandwidth transmitter, the narrow band radio receiver, the narrow band radio transmitter and the sensor system.

10. The safety system of claim 9 wherein the safety system is in operative connection with a self contained breathing apparatus.

11. The safety system of claim 10 wherein the sensor system comprises a motion sensor to detect motion of the person.

12. The safety system of claim 10 wherein the locator system is powered upon activation of the self contained breathing apparatus.

13. The safety system of claim 12 wherein the sensor system comprises a motion sensor to detect motion of the person and a sensor to measure pressure in a tank of breathing gas forming a part of the self contained breathing apparatus.

14. A network system comprising:
a plurality of locator systems, each of the locator systems comprising:
a receiver to receive ultra-wide bandwidth signals and a transmitter to transmit ultra-wide bandwidth signals;
the transmitter being adapted to transmit ultra-wide bandwidth signals and the receiver being adapted to receiving ultra-wide bandwidth signals from at least one other locator system, the at least one other locator system comprising a receiver to receive ultra-wide bandwidth signals and a transmitter to transmit ultra-wide bandwidth signals;
the locator system being adapted to be in a low-power mode until activated upon receipt of an activation signal.

15. The network system of claim 14 wherein the plurality of locator systems form an ad hoc network.

16. The network system of claim 14 wherein the plurality of locator systems form a mesh network.

17. A network system comprising:
a plurality of safety systems, each safety system adapted to be associated with a mobile person, each safety system comprising:
a locator system comprising a receiver to receive ultra-wide bandwidth signals and a transmitter to transmit ultra-wide bandwidth signals;
a telemetric communication system adapted to communicate telemetric data;
a sensor system comprising at least one sensor adapted to measure at least one parameter,
the locator system being adapted to be in a low-power mode until activated upon communication of an activation signal to the locator system, the locator system transmitting ultra-wide bandwidth signals periodically and receiving periodic ultra-wide bandwidth signals from at least one other like locator system upon activation.

18. The network system of claim 17 wherein the plurality of safety systems form an ad hoc network.

19. The network system of claim 17 wherein the plurality of safety systems form a mesh network.
